(19) United States
(12) Patent Application Publication
(10) Pub. No.: US 2009/0299811 A1
(43) Pub. Date: Dec. 3, 2009

(54) SYSTEM AND METHOD FOR TASK MANAGEMENT

(75) Inventors: Neal R. Verfuerth, Plymouth, WI (US); Michael J. Potts, Plymouth, WA (US); John H. Scribante, Plymouth, WI (US); David E. Bakkom, Cedar Grove, WI (US)

Correspondence Address: FOLEY & LARDNER LLP, 777 EAST WISCONSIN AVENUE, MILWAUKEE, WI, 53202-5306, US

(73) Assignee: Orion Energy Systems, Inc.

(21) Appl. No.: 12/471,291

(22) Filed: May 22, 2009

Related U.S. Application Data
(60) Provisional application No. 61/056,648, filed on May 28, 2008.

(51) Int. Cl. G06Q 10/00; G06Q 50/00

(52) U.S. Cl. 705/9; 705/10

(57) ABSTRACT

An method for managing a sales process via a graphical user interface (GUI) generated by a computer and displayed on a computer display is described. The method includes the step of defining a sales process, the sales process including a first task assigned to first assignee and a second task. The method further includes, at the GUI, displaying a prompt for an identifier of a second assignee upon receipt of an indication that the first task has been completed. The method yet further includes receiving the identifier of the second assignee and assigning the second assignee to the second task. The assignment of the second assignee to the second task is displayed on the computer display, stored in a computer memory device, or displayed on the computer display and stored in a computer memory device.

### CROSS-REFERENCE TO RELATED APPLICATIONS

The present application claims the benefit of U.S. Provisional Application No. 61/056,648, filed May 28, 2008. U.S. Provisional Application No. 61/056,648 is hereby incorporated by reference in its entirety.

### BACKGROUND

The present invention relates generally to the field of task management. The present invention more particularly relates to the fields of customer relationship management (CRM) software and project management software.

As the number of sales contacts and leads for an individual or company grow, managing the contacts and leads becomes cumbersome. CRM software is intended to facilitate the management of contacts and sales leads via a graphical user interface (GUI) generated by the software and driven by one or more databases. Project management software is intended allow a firm to manage its projects via another GUI once the sale is earned.

Applicants have discovered improved systems and methods for managing and facilitating tasks (e.g., sales tasks, installation tasks, etc.) in a forward-looking manner.

### SUMMARY

One embodiment of the invention relates to a method for managing a sales process via a graphical user interface (GUI) generated by a computer and displayed on a computer display. The method includes the step of defining a sales process, the sales process including a first task assigned to first assignee and a second task. The method also includes the step of, at the GUI, displaying a prompt for an identifier of a second assignee upon receipt of an indication that the first task has been completed. The method further includes the step of receiving the identifier of the second assignee and assigning the second assignee to the second task. The assignment of the second assignee to the second task is displayed on the computer display, stored in a computer memory device, or displayed on the computer display and stored in a computer memory device.

Another embodiment of the invention relates to a computer for providing a GUI for managing a sales process, the sales process including a first task assigned to a first assignee and a second task for assigning to a second assignee. The computer includes a memory unit and a processing circuit communicably coupled to the memory unit and configured to receive first input regarding the sales process via the GUI and to use the first input to define the sales process within the memory unit. The processing circuit is further configured to receive an indication that the first task has been completed via the GUI and to cause the GUI to display a prompt for an identifier of the second assignee upon receipt of the indication. The processing circuit is further configured to receive the identifier of the second assignee and to assign the second assignee to the second task. The processing circuit is further configured to cause the GUI to display a record of the assignment of the second assignee to the second task, to store the record in the memory unit, or to cause the GUI to display the record and to store the record.

Another embodiment of the invention relates to a system for managing a sales process, the system configured to generate a graphical user interface (GUI) for allowing a user to manage sales processes for a plurality of sales projects. The system includes a processing circuit configured to maintain a record of a total cost for each sales project of the plurality of sales projects, wherein the processing circuit is configured to prompt the user for updated cost information after tasks relating to each sales project are updated as completed via the GUI. The processing circuit is configured to display an indication of the total cost for a sales project of the plurality of sales projects near an indication of the potential revenue relating to the sales project on the graphical user interface of the system.

Another embodiment of the invention relates to a system for managing a sales process, the system configured to generate a graphical user interface (GUI) for allowing a user to manage sales processes for a plurality of sales projects. The system includes a processing circuit configured to maintain a record of the meeting instances during which a customer contact relating to the sales process met with a sales representative and wherein the processing circuit is further configured to calculate the period of time since the last meeting instance and to prompt the user to initiate a sales process task for meeting with the customer contact. The processing circuit is further configured to display a map on the graphical user interface, the map including an indicator of a location associated with the customer contact and at least another indicator for another customer contact.

Another embodiment of the invention relates to a system machine readable storage medium storing a computer program for use by a computer and for managing a sales process via a graphical user interface (GUI) generated by the computer and displayed on a computer display. The computer program is adapted to make a computer execute the process including the steps of defining the sales process, the sales process including a first task assigned to first assignee and a second task and, at the GUI, displaying a prompt for an identifier of a second assignee upon receipt of an indication that the first task has been completed. The process further includes the steps of receiving the identifier of the second assignee and assigning the second assignee to the second task. The assignment of the second assignee to the second task is displayed on the computer display and/or stored in a computer memory device.

Another embodiment of the invention relates to a first computer for transmitting a computer program for use by a second computer. The computer program is adapted to make a computer execute the process including the steps of defining the sales process, the sales process including a first task assigned to first assignee and a second task and, at the GUI, displaying a prompt for an identifier of a second assignee upon receipt of an indication that the first task has been completed. The process further includes the steps of receiving the identifier of the second assignee and assigning the second assignee to the second task. The assignment of the second assignee to the second task is displayed on the computer display and/or stored in a computer memory device.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a graphical illustration of a method for managing a sales process via a GUI generated by a computer and displayed on a computer display;

FIG. 2 is a block diagram of a computer system for managing the sales process of FIG. 1, according to an exemplary embodiment;

FIG. 3 is an illustration of a GUI provided by the computer system shown in FIGS. 1 and 2, according to an exemplary embodiment;

FIG. 4 is an illustration of a GUI provided by the computer system shown in FIGS. 1 and 2, according to an exemplary embodiment;

FIG. 5 is an illustration of a GUI provided by the computer system shown in FIGS. 1 and 2, according to an exemplary embodiment;

FIG. 6 is an illustration of a GUI provided by the computer system shown in FIGS. 1 and 2, according to an exemplary embodiment;

FIG. 7 is an illustration of a GUI provided by the computer system shown in FIGS. 1 and 2, according to an exemplary embodiment;

FIG. 8 is an illustration of a GUI provided by the computer system shown in FIGS. 1 and 2, according to an exemplary embodiment;

FIG. 9 is an illustration of a GUI provided by the computer system shown in FIGS. 1 and 2, according to an exemplary embodiment;

FIG. 10 is an illustration of a GUI provided by the computer system shown in FIGS. 1 and 2, according to an exemplary embodiment;

FIG. 11 is a flow chart of a process 1100 for managing a sales project using a computer system as described in the present application, according to an exemplary embodiment;

FIG. 12 is a flow chart of a process 1200 for managing a sales project using a computer system as described in the present application, according to an exemplary embodiment;

FIG. 13 is a flow chart of a process 1300 for managing a sales project using a computer system as described in the present application, according to an exemplary embodiment;

FIG. 14 is an illustration of a GUI provided by the computer system shown in FIGS. 1 and 2, according to an exemplary embodiment;

FIG. 15 is an illustration of a GUI provided by the computer system shown in FIGS. 1 and 2, according to an exemplary embodiment; and

FIG. 16 is an illustration of a GUI provided by the computer system shown in FIGS. 1 and 2, according to an exemplary embodiment.

### DETAILED DESCRIPTION OF THE EXEMPLARY EMBODIMENTS

Before turning to the figures which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, systems and methods for managing sales processes and sales tasks are described. Software installed on a computer (e.g., a server) is configured to generate a GUI for display on a computer display. The GUI can be used to define one or more sales processes, the sales processes including multiple tasks. The GUI is configured to be forward-looking, or to focus users on the next task in the sales process to be completed. For example, as a first user completes a first task (e.g., marks a task as complete in the system) the system will “push” prompts to the user for defining the next task (if not defined) and for assigning the next task to the first user or another user. The system can then undertake one or more activities to ensure the next task is completed (e.g., tracking tasks to be completed via the GUI views provided to assignees and assignors). While the systems and methods are described with reference to a sales project and/or sales tasks, it should be appreciated that the systems, methods, and graphical user interfaces may be modified to accommodate other task-based processes (e.g., customer service, warranty support, etc.).

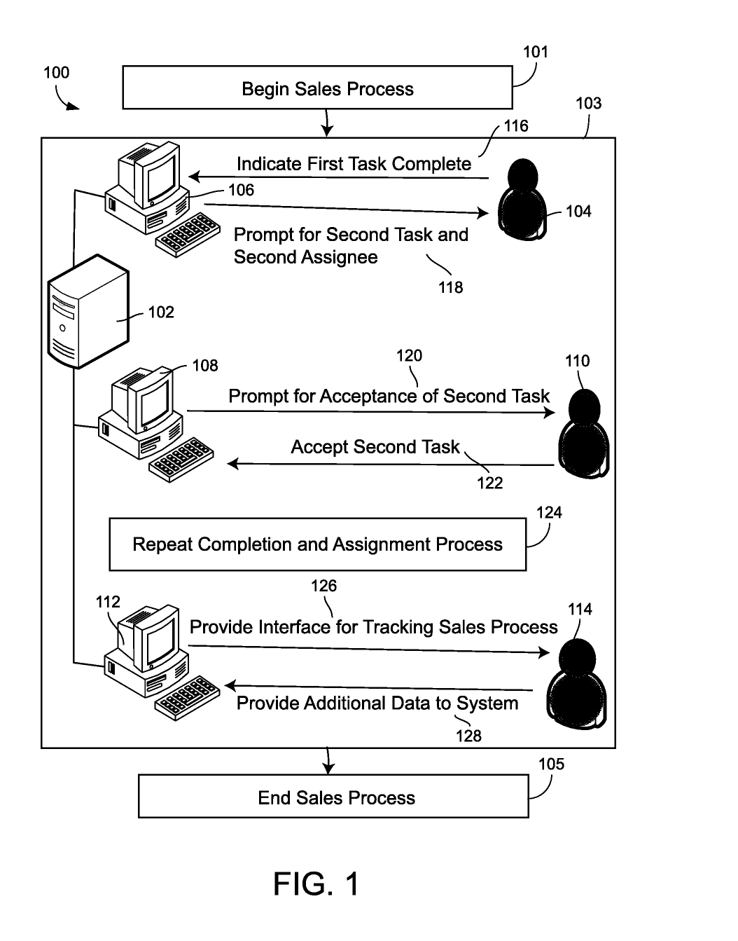

Referring now to FIG. 1, a graphical illustration of a method 100 for managing a sales process via a GUI generated by a computer and displayed on a computer display is shown, according to an exemplary embodiment. A sales process typically begins (step 101) when a lead is entered identified and entered into the system. Step 101 may include any number of steps described later in the present application. For example, step 101 may include entering a contact for the sale into a computer system (e.g., server computer 102 and client device 106).

Once a sales process has begun, the computer system is used to manage the sales process (step 103), tasks for the project, and/or sub-tasks for the project. During the sales process, and step 103 in particular, the computer system generates a GUI (screen shots of which are shown in subsequent figures) for providing to one or more computer displays or clients (e.g., client 106, client 108, client 112). A first user 104 may log into the GUI via client device 106. When user 104 completes his or her first task, user 104 should indicate that the first task of a sales process is complete via the GUI (step 116). The server computer 102 may receive this indication (e.g., in the form of one or more digital and/or analog signals, etc.) via communications with the GUI and/or client device 106. The computer system (e.g., via client device 106) is then configured to recognize the completion of the task and to prompt for a second task and second assignee for the second task (step 11 8). When the user enters the second task and the second assignee to the GUI, the computer is configured to notify the second assignee 110 and to prompt second assignee 110 for acceptance of the second task (step 120). Second assignee 110 can then accept the second task (step 122). The sales force (e.g., including the first and second assignee) can repeat (step 124) the task completion and assignment process until the sales process is complete. According to an exemplary embodiment, the computer system can also provide an interface (e.g., via client device 112) for tracking the sales process and/or task progress (step 126) of users 104, 110, and/or user 114 (e.g., sales manager, assigning user, etc.). User 114 may also provide additional data to the system (step 128) so that the system can track, store, and report on other metrics relating to the sales process.

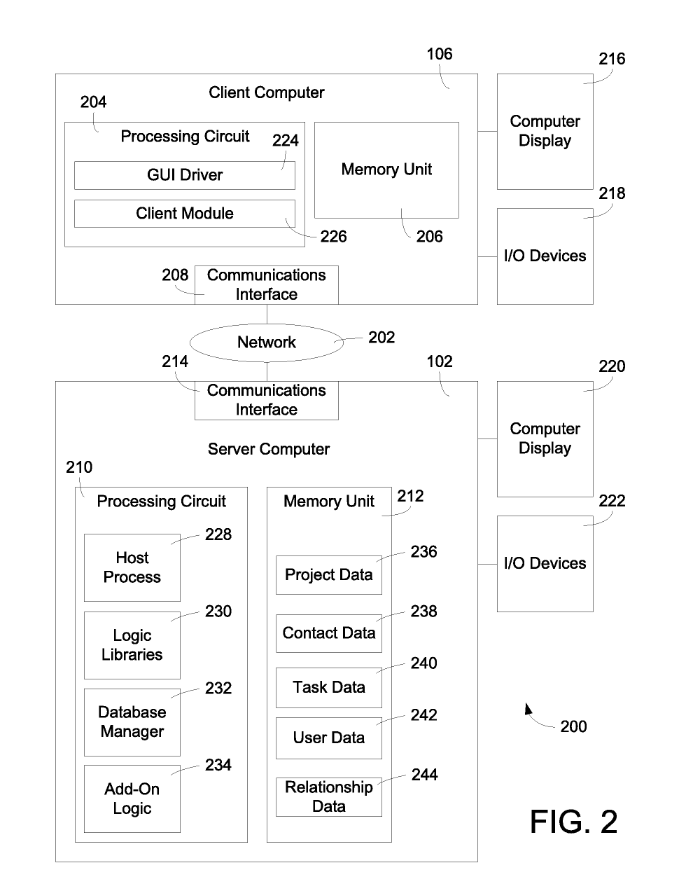

Referring to FIG. 2, a block diagram of the computer system 200 described in FIG. 1 is shown, according to an exemplary embodiment. Computer system 200 is shown to include server computer 102 and client computer 106 in communication via network 202. While computer system 200 is shown as a client-server system and/or involving more than one computer, it is important to note that other system designs are possible. For example, computer 106 may include all the data and logic to complete the activities described in the present application. Furthermore, various other exemplary embodiments may include any number of gradations between a “thin” web-client computer system (e.g., the majority of the logic and data are stored on a server but a web-client is used to provide the GUI to a computer display/user), and a “fat” client system (e.g., the client has the ability to perform most of the logic for completing the activities described in the present application but accesses a server for data and/or some limited application support).

Client computer 106 is shown to include processing circuit 204, memory unit 206, and communications interface 208. Server computer 102 is shown to include processing circuit 210, memory unit 212 and communications interface 214. Processing circuits 204 and 210 may include any number of processing and/or electronics components of the past, present, and future for conducting the activities described in the present application. For example, processing circuits 204 and 210 may include one or more general purpose processors configured to execute computer code residing within memory of the processing circuit, computer code residing in memory unit 206 or 212, or computer code residing on a remote source or computer readable medium. Processing circuits 204 and 210 may also (or alternatively) include any number of application specific integrated circuits (ASICs), field programmable gate arrays (FPGAs), power supply components, volatile memory components, non-volatile memory components, or any other combination of hardware and/or software components. Communications interface 208 and communications interface 214 may be configured to directly communicate or to communicate over one or more networks (e.g., network 202). Communications interfaces 208 and/or 214 may be configured to operate according to any number of wired and/or wireless communications standards or protocols. Communications interfaces 208 and/or 214 may be of the same type or of a different type and may include any number of hardware and/or software components configured to facilitate communications.

Referring further to FIG. 2, client computer 106 is shown communicably coupled to computer display 216. Computer display 216 can be any display of the past, present, or future capable of generating the GUIs described herein. Computer display 216 may be remote from or located near to client computer 106. Processing circuit 204 may include circuitry for driving and/or controlling computer display 216 (e.g., a display driver and a hardware interface for connecting and driving electronic signals to computer display 216). Client computer 106 is further shown communicably coupled to I/O devices 218. I/O devices 218 may include one or more keyboards, pointing devices, or the like for interacting with a GUI shown on computer display 216. Client computer 106 may include any number of hardware and/or software components for interpreting inputs received at I/O devices 218 and/or for controlling I/O devices 218. Server computer 102 may also be communicably coupled to a computer display 220 and/or to input devices 222. Computer display 220 and input devices 222 may be used for administrative access to the computer system.

Processing circuit 204 is shown to include GUI driver 224 and client module 226. GUI driver 224 may be hardware and/or software for generating the GUI shown on computer display 216. For example, GUI driver 224 may include software libraries and/or computer code for laying out GUI elements and controls. Client module 226 may be executable software, computer code, computer scripts, collections of software, or the like for processing input received from the GUI (e.g., I/O devices 218) and for providing output to the GUI (e.g., via computer display 216) based on logic of the system. Client module 226 may coordinate a connection to server computer 102, one or more database connections, and/or other communications with the server computer. According to various alternative embodiments, client module 226 and/or GUI driver 224 may be implemented on a personal digital assistant, mobile phone, laptop, or other portable electronic device configured for the activities described in the present application. The client module provided to portable electronic devices may be a thin client while the client module provided to desktop installations may include a full client. For example, a portable electronic device (e.g., an internet-enabled phone) may be able to receive alerts and to update tasks via the portable electronic device but may not be able to view full details for a project and/or task.

Processing circuit 210 of server computer 102 is shown to include host process 228, logic libraries 230, database manager 232, and add-on logic 234. According to an exemplary embodiment host process 228, logic libraries 230, database manager 232, and/or add-on logic 234 may be loaded into volatile memory for runtime from non-volatile memory (e.g., a hard drive, a bank of solid state flash memory, etc.) or another computer-readable medium (e.g., CDROM). Host process 228 may be responsible for communicating with client module 226 and may include computer code for the primary algorithms and/or logic for the methods described herein. Logic libraries 230 may be or include function libraries for interfacing with GUI driver 224, communications interface 214, and/or the operating system of server computer 102. Logic libraries 230 may also include common queries used by database manager 232 and/or host process 228. Database manager 232 may be a process for facilitating writing to and reading from one or more connected databases. Database manager 232 may be configured to manage connections from multiple client devices, users, and/or processes that are accessing the connected databases. Add-on logic 234 may include other components or software functions for completing and facilitating supporting or ancillary features of the systems and methods described herein. According to an exemplary embodiment, add-on logic 234 modules may be added and/or removed from computer system 200 at either the client device or the server device to customize the functionality offered to end users of the system.

Referring further to FIG. 2, memory unit 212 is shown to include project data 236, contact data 238, task data 240, user data 242, and relationship data 244. Memory unit 212 may be non-volatile memory and/or volatile memory. Project data 236 is a set of data regarding sales projects for computer system 200. Contact data 238 is a set of data regarding contacts for sales projects. Task data 240 is a set of data regarding tasks for the sales projects of the computer system. User data 242 is a set of data regarding users of the system (e.g., users 104, 110, 114 shown in FIG. 1). Relationship data 244 is a set of data relating projects from project data 236, contacts from contact data 238, tasks from task data 240, and/or users from user data 242. Data sets 236-244 may be stored in non-volatile memory, in databases, in one or more flat files, tables, or any other suitable components and/or data structures.

A GUI generated by system 200 can be a system that users continuously check and/or update to drive their sales day and other activities. According to an exemplary embodiment, I/O devices 218 includes a phone system (e.g., a desk phone, an IP phone, etc.) configured to pass caller identification information to system 200. Upon receipt of the caller identification information the system may be configured to generate a notification via the GUI presented to the user. Processing circuit 204 and/or 210 may also be configured to lookup a customer contact record based on the received identification information. Based on the lookup a new GUI screen may be shown to the user that lists details regarding the caller, the projects relating to the caller, the tasks relating to the caller, and/or any number of details stored in system 200.

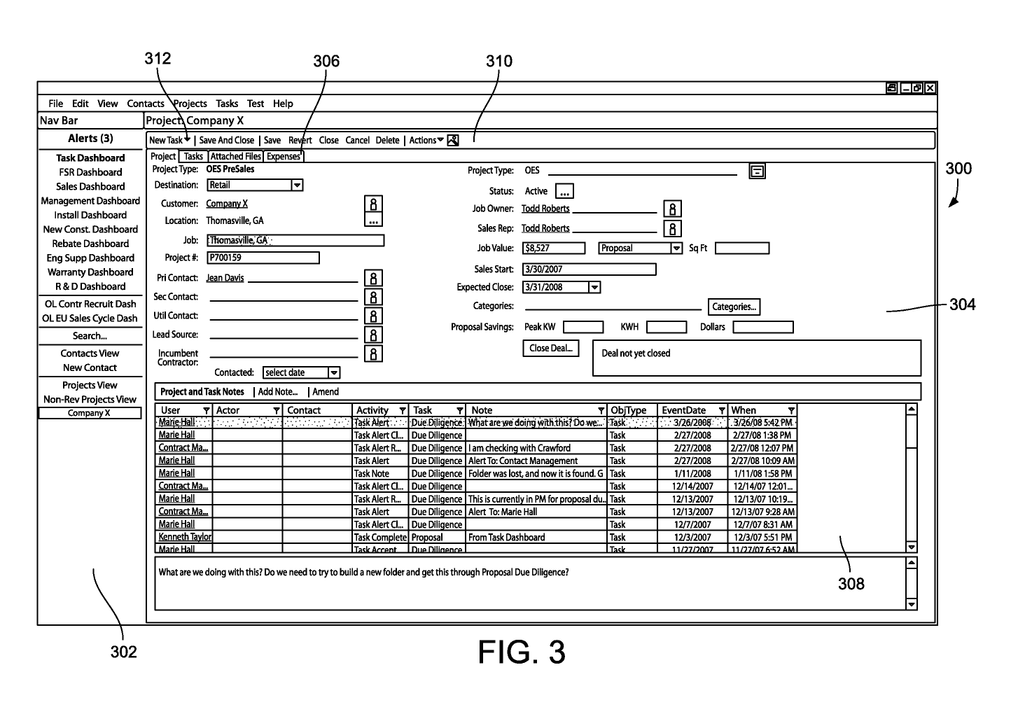

Referring now to FIG. 3, an illustration of a GUI 300 provided by the computer system shown in FIGS. 1 and 2 is shown, according to an exemplary embodiment. GUI 300 may be configured to allow users to add and/or update data relating to one or more sales projects. GUI 300 is shown to include navigation bar (“nav bar”) 302, workspace 304, and selection tabs 306. Other user interface controls may be used and/or organized in different ways. Nav bar 302 may be used to navigate between different categories of content to be displayed in workspace 304. Selection tabs 306 may be used to further define or narrow the data and/or user interface elements displayed in workspace 304. According to the example shown in FIG. 3, a “project” category of content is selected, and a project tab is shown selected over the various selection tabs 306. The resulting workspace 304 allows a user to enter and/or edit data relating to a project. As shown in FIG. 3, a user can enter a variety of characteristics for each project (e.g., project type, destination, customer, location, job name, project number, a primary contact, other contacts, the project status, timelines related to the project, financials relating to the project, a job owner, a sales representative, etc.).

According to an exemplary embodiment each project can include one or more related tasks. Tasks may be defined as activities defined to be necessary or desired for the completion of a project. FIG. 3 illustrates a list control 308 within workspace 304 that lists a history of the notes associated with the project of workspace 304. List control 308 may show the user of GUI 300 key parameters for each task. According to various exemplary embodiments the user may directly edit the parameters displayed on list 308. According to yet other exemplary embodiments the user must navigate to other views (e.g., the tasks tab of the selection tabs 306) in order to add or otherwise edits tasks for one or more projects.

GUI 300 is further shown to include activity bar 310. Activity bar 310 may include buttons, hotspots, or other user interface controls. Activity bar 310 is shown to include a new task button 312. When clicked or otherwise triggered, new task button 312 is configured to provide a new workspace view, a pop-up form, or dialog box for allowing a user to enter details regarding the new task. Details regarding the new task may include which user should be assigned the task, a task type, a due date for the task, a sales contact relating to the task, notes regarding the task, a category for the task, or any other number of fields configured to describe a task. When new task button 312 is pressed while viewing a certain project (e.g., “Project: Company X”), the system may be configured to relate the new task to the project (e.g., update a record in relationship data 244).

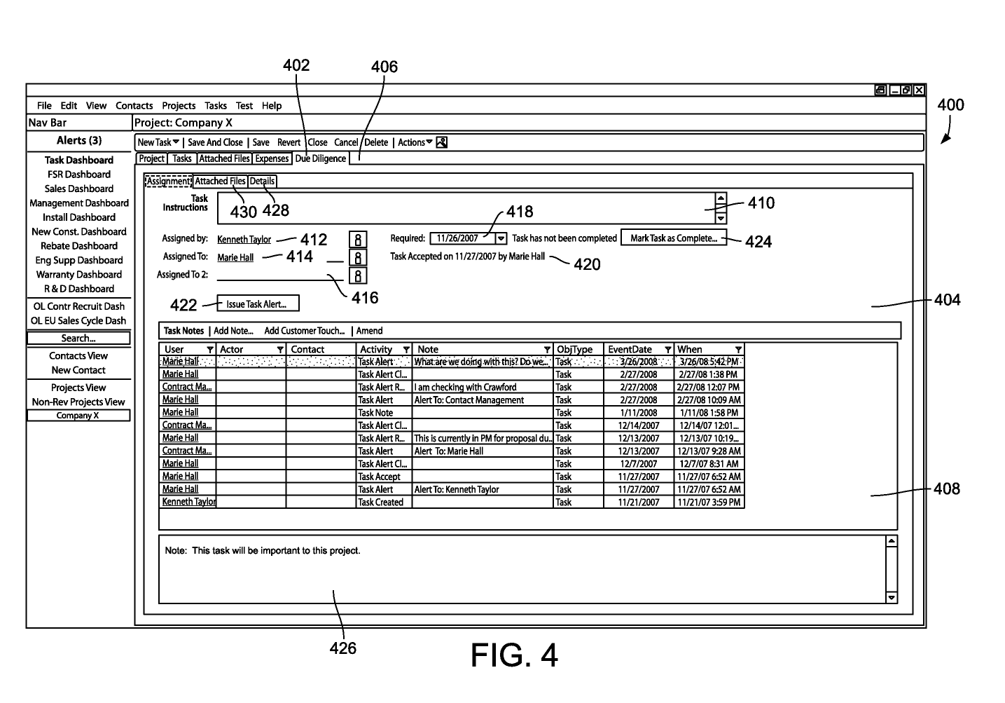

Referring now to FIG. 4, an illustration of a GUI 400 provided by the computer system shown in FIGS. 1 and 2 is shown, according to an exemplary embodiment. A “due diligence” tab 402 on selection tab 406 is shown as selected. Due diligence is a type of project or project task and the contents of workspace 404 may be substantially similar to those for other task categories (e.g., installation tasks, project tasks, etc.). List 408 may list the task activity (e.g., sub-task activity) relating to the due diligence task. The remainder of workspace 404 may be dedicated to providing controls for defining a task. Text box 410 may be configured to allow a user to describe the task and/or enter task instructions. When a task is entered to the system the user entering the task may be the assignor. According to an exemplary embodiment, however, the user entering the task may input a different assignor for a task in area 412. An assignee may be defined (e.g., entered, selected, etc.) via area 414. Other assignees (or backup assignees) may be defined in area 416. When a task is assigned to a user, the system may be configured to ensure that the assignee accepts the task by a certain date in order to keep the project moving forward. The system may facilitate this step by allowing the assignor to enter a date (e.g., via control 418) by which the assignee must accept, decline, and/or complete the task. A task acceptance indicator 420 may inform users of the system of whether the intended assignee has accepted the task.

While GUI 400 may be used to enter a task for the first time, GUI 400 may also be used to manage tasks. Issue task alert button 422 may be used to generate an alert to the one or more users, alerting them to urgent requests. For example, the issue task alert button may be used to generate an alert to the intended assignee or present assignee, alerting them to an upcoming required acceptance date or other deadline. The logic executed when issue task alert button 422 is pressed may also be configured to send copies of any alerts to supervisors, assignors, or managers of the project. If a task has been completed, a first user can use control 424 to mark a task as complete. When control 424 is triggered, a dialog box, form, or new workspace 404 may be displayed that prompts a user to enter details regarding the completion (e.g., the completion date, the expenses associated with completing the task, etc.). According to an exemplary embodiment the system includes logic for facilitating a forward-looking sales management process by requiring the assignment of a second task when a first task has been completed. For example, once the system receives an indication that a task has been completed, the system may be configured to automatically prompt the user marking the task as complete to define the next task or to confirm that the next task or tasks are properly defined. Further narrative for the task may be viewed, added, and/or edited via text box 426. Details tab 428 may allow the user to enter yet further details relating to the project. Attached files tab 430 may allow the user to upload one or more files that are relevant to the due diligence project, a particular task, or otherwise.

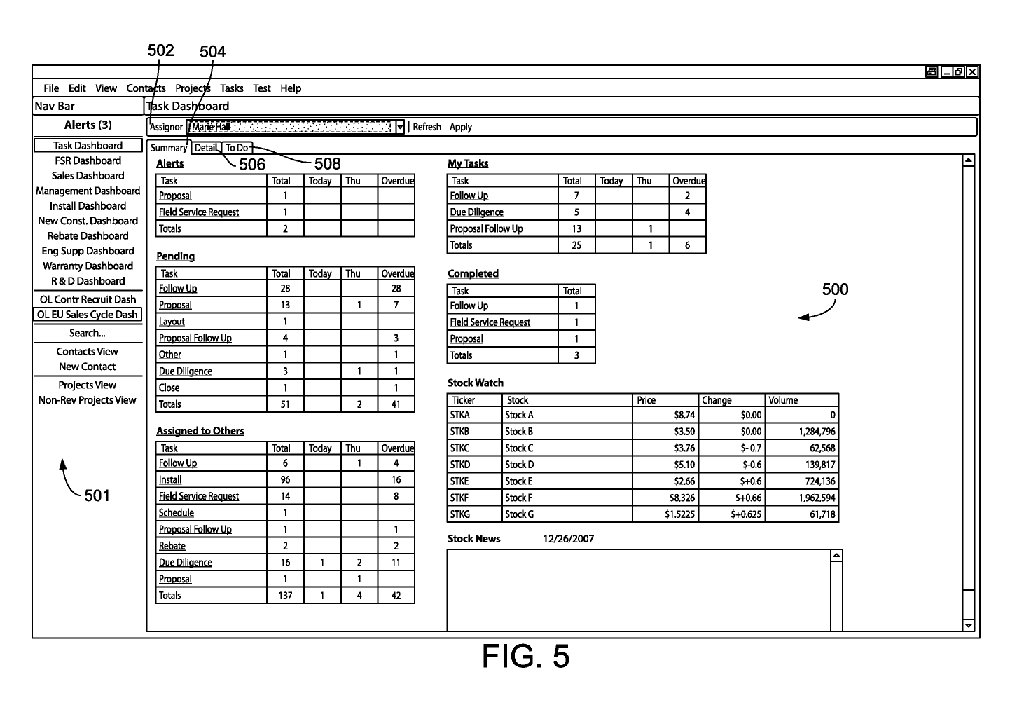

Referring now to FIG. 5, an illustration of a GUI 500 provided by the computer system shown in FIGS. 1 and 2 is shown, according to an exemplary embodiment. Assignor 502 or another user may view GUI 500 when “task dashboard” is clicked on nav bar 501. The task dashboard shown on GUI 500 is configured to allow a user to view a summary of the status of all tasks relating to the user (or another user) when summary tab 504 is active. By quickly glancing at the task dashboard summary shown in FIG. 5 the user may be able to understand his or her workload, an area of focus, a lagging area, or another determination regarding the tasks relating to the user. As shown, a variety of categories of information may be summarized (e.g., alerts, pending tasks, tasks assigned to others, tasks for the user to complete personally (my tasks), completed tasks, stock watch information, and stock news) and different task categories can be broken out (e.g., follow-up tasks, proposal tasks, due diligence tasks, etc.). Detail tab 506 may be configured to present a detailed lists of all tasks associated with the user (e.g., on a task-by-task basis). “To do” tab 508 may be configured to show the to do items created by the user as personal reminders. According to various other alternative embodiments the “To do” tab may be configured to filter the tasks associated with the user to provide a list only of those items that are open (e.g., not completed). The to-do list may be sorted by due date. One or more of the categories may be hyperlinked or otherwise configured as GUI controls so that clicking on the text for a category will provide a detailed view (e.g., switch to a detail tab, pop-up a detailed-view window, etc.).

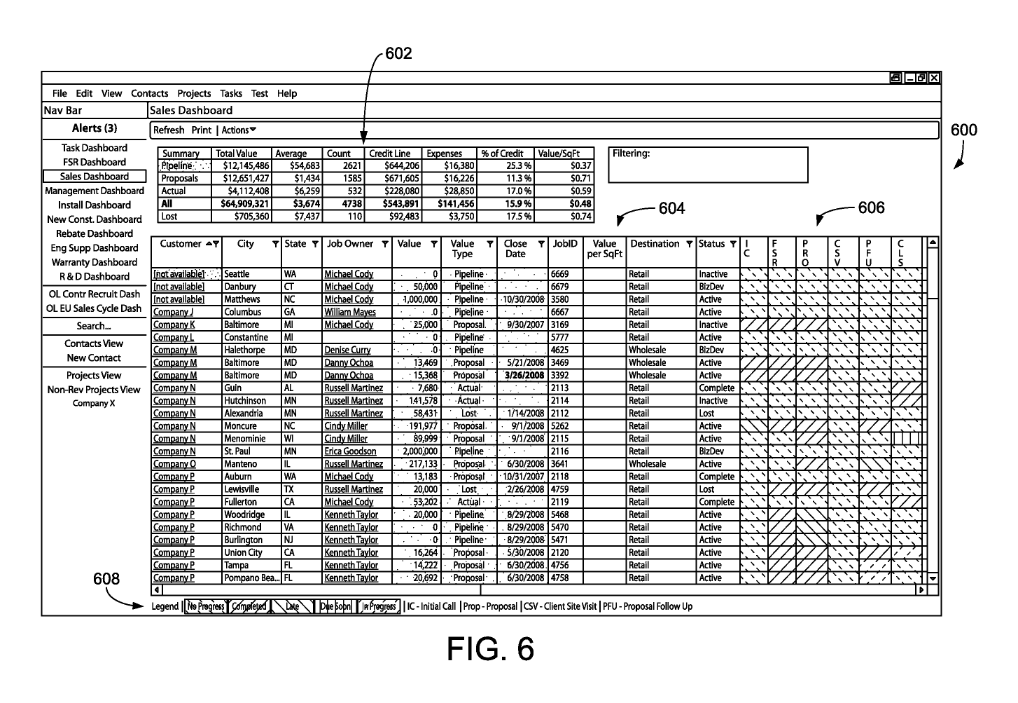

Referring now to FIG. 6, an illustration of a GUI 600 provided by the computer system shown in FIGS. 1 and 2 is shown, according to an exemplary embodiment. GUI 600 is a “sales dashboard” view of projects in the system. The sales dashboard is shown to include a financial summary table 602, a detailed project summary listing 604, and a status chart 606. Financial summary table 602 provides aggregate values for sales in the pipeline, sales actually proposed, sales actually made (“actual”), lost sales, and the total potential sales (“All”) for a period of time (e.g., a month, a quarter, a year, a fiscal year, etc.). Other metrics such as the average sales project, the number of projects in the pipeline, a credit line (e.g., budget allocated) for the sales categories, expenses, value per square foot of installation space, and/or other metrics may be displayed in financial summary 602. Detailed project summary listing 604 is shown to include the name of the associated customer, the location (e.g., city, state), the project or “job” owner, the value (e.g., expected, projected, actual) for the project, the value type, the close date (e.g., when the project will be completed, when the project was confirmed lost, etc.), a destination category, a broad status, and any other information. Detailed project summary listing 604 is also shown next to status chart 606. The system may be configured to generate status chart 606 by examining the tasks associated with the project. According to the exemplary embodiment shown in FIG. 6, status chart 606 shades project and status fields to signify different statuses. Legend 608 allows a user to understand what the different shades mean.

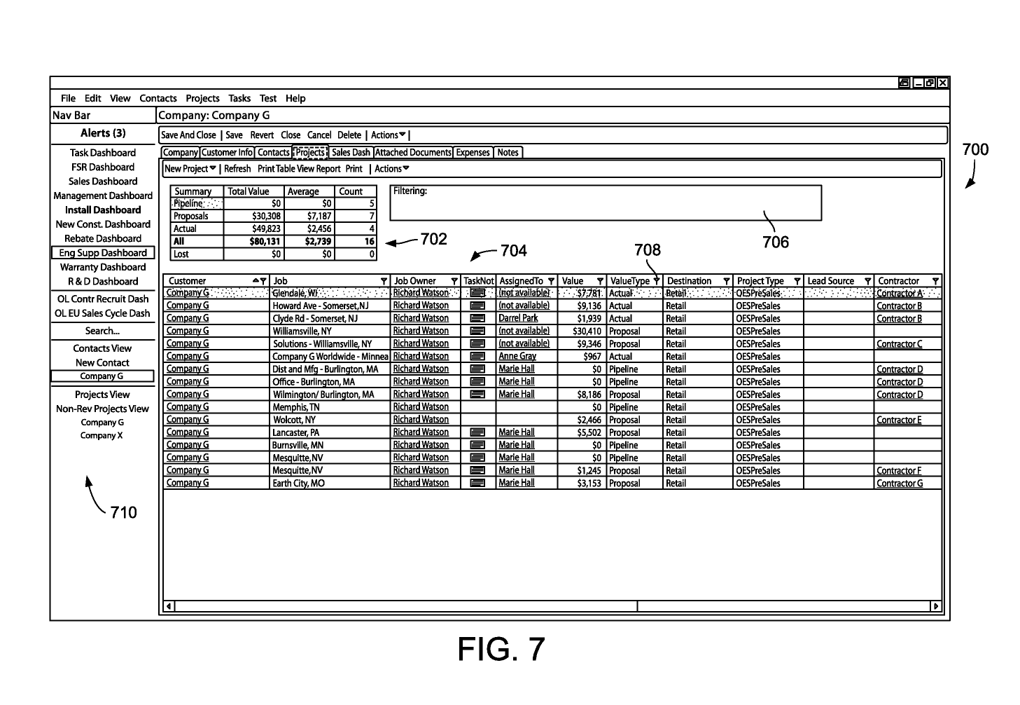

Referring now to FIG. 7, an illustration of a GUI 700 provided by the computer system shown in FIGS. 1 and 2 is shown, according to an exemplary embodiment. GUI 700 is shown to include projects relating to “Company G”. GUI 700 may be obtained by clicking on a company name in another view or by searching for a customer company (or potential customer company). GUI 700 is shown to include financial summary table 702 configured to display financial totals relating to the selected company. Detailed project summary listing 704 is configured to display project details relating to the selected company. Accordingly, the system is configured to populate detailed project summary listing 704 with information such as the name of the contractor scheduled to assist with each project.

According to various exemplary embodiments, GUI controls for sorting and/or filtering data provided to the GUI screens of the system are provided to the user. For example, sort control 708 may be clicked to sort the data of detailed project summary listing 704 by the field “ValueType”. By way of another example, all projects for a company, a contractor, or a user may be filtered so that efforts may be observed or coordinated. Filters may be used to define filters (e.g., queries) for the data. Filter control 708, for example, may be used to type in natural language queries, SQL queries, or the like. Sort controls similar to or different from sort control 708 may be provided to one or more of the other fields. GUI 700 is further shown to include filter summary 706 which shows all currently defined filters. According to other exemplary embodiments clicking on filter control 708 allows a user to define a filter via a “filter wizard” or a process that assists the user with building a filter using questions, prompts, or other processes.

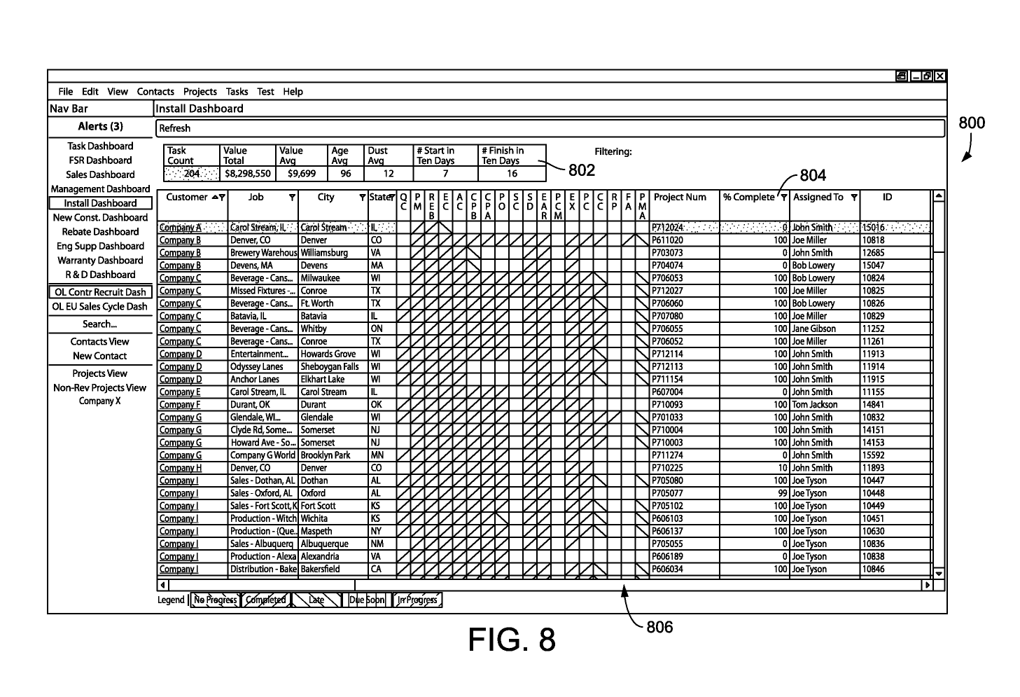

Referring now to FIG. 8, an illustration of a GUI 800 provided by the computer system shown in FIGS. 1 and 2 is shown, according to an exemplary embodiment. GUI 800 displays “install dashboard” data configured to convey the status of installation projects to a user. Summary table 802 provides aggregate counts and financial totals to provide the user with an overview so that he or she may better plan and/or allocate resources. Detail table 804 is a list of companies, jobs (i.e., projects), and includes a status chart 806. Similar to status chart 606 shown in FIG. 6, various status fields may be shaded differently to indicate that different key tasks in the installation process have been completed. It is important to note that some tasks (e.g., an installation task) can have multiple sub-tasks that can be tracked by the system, assigned to users, checked for age, and the like. While the main tasks for a project may be predefined, other main tasks and/or sub-tasks may not be predefined. For example, a particular installation might require some unique tasks that allow a user to create a new task.

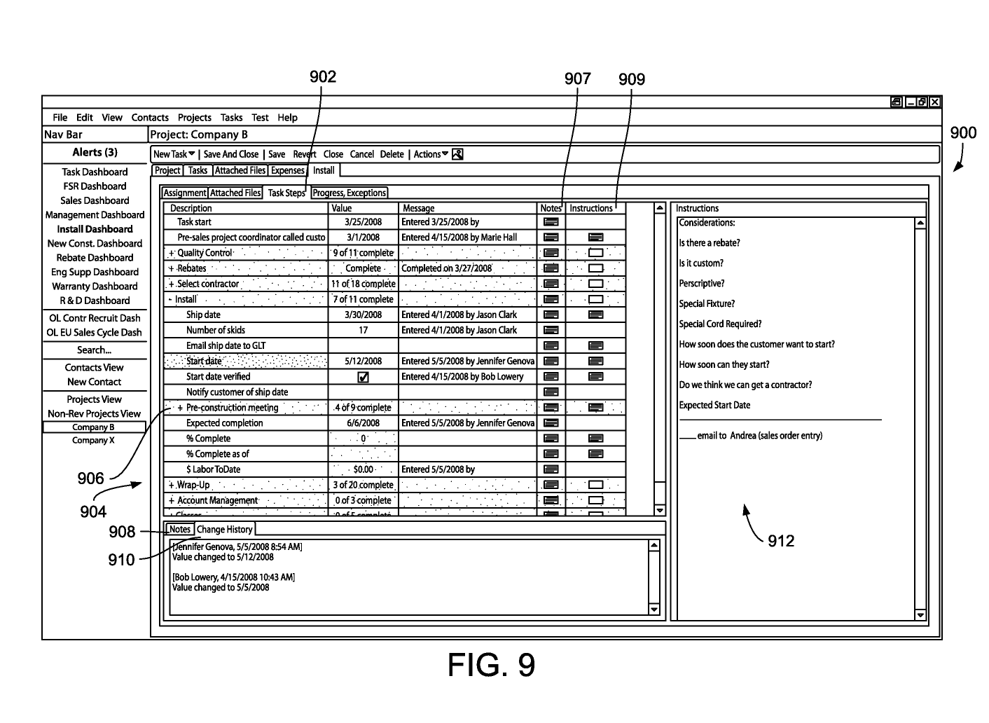

Referring now to FIG. 9, an illustration of a GUI 900 provided by the computer system shown in FIGS. 1 and 2 is shown, according to an exemplary embodiment. GUI 900 displays a screen associated with “task steps” tab 902 and that shows a detailed summary 904 of task steps for a single task for a single project. Detailed summary 904 includes a list of key metrics. According to an exemplary embodiment, the various items on the list are expandable. For example, by clicking on a plus mark 906 the nine tasks relating to the “pre-construction meeting” may be displayed with detailed information regarding the tasks (e.g., the expected completion date, the percent complete, when entered, etc.). According to an exemplary embodiment, any item may be annotated and/or have instructions attached. Whether an item is annotated or not may be shown via notes column 907. Whether an item is associated with stored instructions or not may be shown via instructions column 909. Icons within notes column 907 and instructions column 909 may be clicked to retrieve the associated notes and/or instructions. According to an exemplary embodiment notes are shown in notes tab 908 and instructions are shown in instructions area 912. According to an exemplary embodiment a history of changes made to the database record for the project and/or the task may be shown in “change history” tab 910. Using GUI 900 a manager or other user is able to quickly determine what tasks have been completed, what tasks must still be done, and then may plan accordingly.

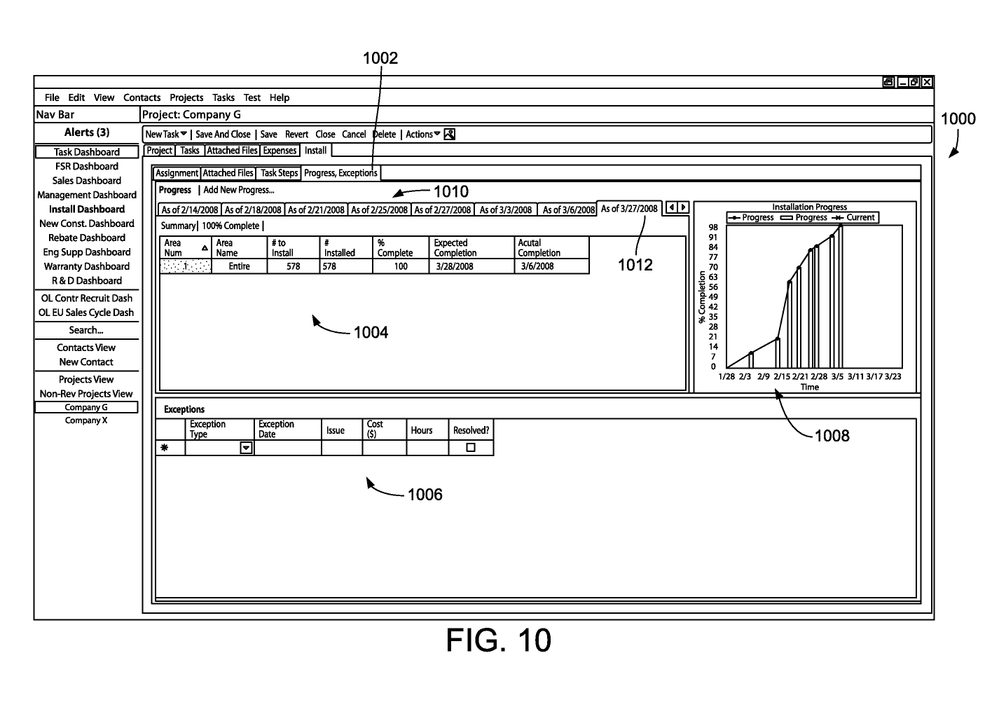

Referring now to FIG. 10, an illustration of a GUI 1000 provided by the computer system shown in FIGS. 1 and 2 is shown, according to an exemplary embodiment. GUI 1000 is shown to display the contents of “Progress, Exceptions” tab 1002 in area 1004. Area 1004 can show the status of the aspects or sub-tasks for an install task, sales tasks, sales projects, or any other type of project. Area 1004 can be based on the number of tasks completed (e.g., fixtures installed) versus the number of tasks associated with a project. For example, in area 1004, five hundred and seventy eight tasks were associated with the project and the same number of tasks were completed so the project is shown as one hundred percent complete. The project was expected to be completed on Mar. 28, 2008, but was actually completed on Mar. 6, 2008 and these facts are indicated in area 1004. Date tabs 1012 may be used to view the history of the task (e.g., the status of the task as of certain dates). A graphical representation 1008 of the installation progress is shown next to area 1004. While the graphical representation 1008 is shown as a bar graph with joining lines, the graphical representation can be formatted in a variety of different ways (e.g., pie chart, Gantt chart, etc.). Exceptions area 1006 may be used to record exceptions (e.g., items or events that are not a part of normal operations or standards). GUI 1000 may allow a user (e.g., a manager) to supervise the progress of installation and/or sales work to ensure that exceptions are resolved in a timely manner and to ensure that the progress on the work is proceeding on schedule.

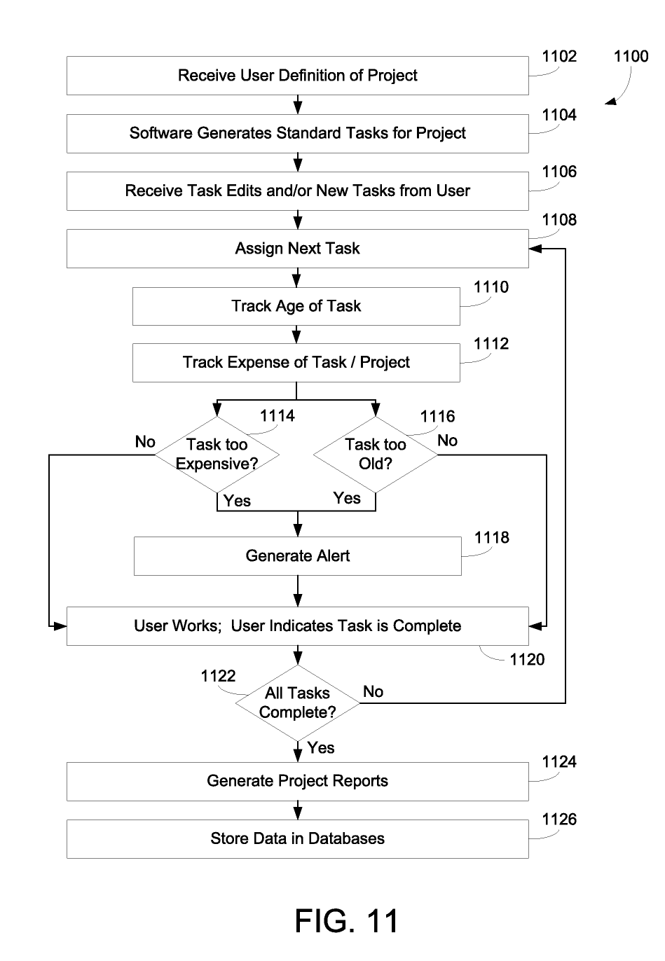

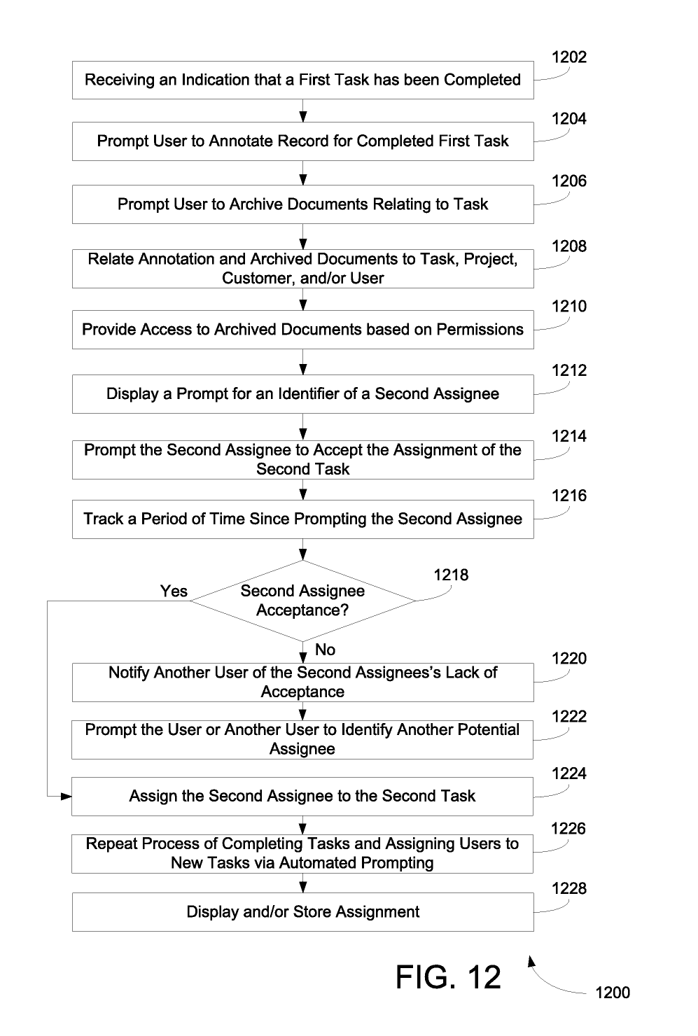

Referring now to FIG. 11, a flow chart of a process 1100 for managing a sales project using a computer system as described in the present application is shown, according to an exemplary embodiment. Process 1100 is shown to include receiving a user definition of a project (step 1102). The user may select from one or more predefined projects or base projects or may select a project shell for population. Depending on the input received, the system may be configured to then generate standard tasks for the project (step 1104). For example, if a sales project is created a first task might be to identify a customer contact and a second task might be to call the customer contact. These tasks might be populated or automatically created upon creation of a sales project. The user may review the automatically generated tasks, edit the tasks, and/or add new tasks (step 1106). Appropriate records and relationships are setup by the system upon receipt of the user's input. According to an exemplary embodiment the system then assigns the next task (e.g., the first task if no tasks have been completed) to the user or another user (step 1108). The user is required to assign the next task via one or more prompts or required fields according to a preferred embodiment. The task assignment project is further described in FIG. 12.

As projects are worked, the age of tasks are tracked (step 1110). For example, the number of hours, days, weeks, or months since the task was created may be tracked. Other periods of time may alternatively be tracked (e.g., time since user acceptance of task, time before due date, time since start of day, time since project start, etc.). Expenses relating to each task and/or project are also tracked. According to an exemplary embodiment step 1102 (receiving user definitions) includes receiving input regarding a credit total for the project. The credit total may calculated based on the sale projected for the project, a pre-established budget, and/or user input. The expense for each task (or the overall project) may be updated when tasks are updated. The system may be configured to determine whether the project and/or task is running over-budget (step 1114). If the project and/or the task is running over-budget, the system is configured to generate an alert for providing to the user, the user's manager, or another user (step 1118). The alert may be or include a “red” shade on a dashboard or status view of the GUI, a text message, an e-mail, a text indication on a dashboard view, a text indication on a nav bar, or otherwise.

Process 1100 is also shown to include determining whether any task is too old (step 1116). This determination may be based on a threshold number of days associated with the task type, a percentage of the time required to complete the project, a completion date requested by a potential customer, or any other number or calculation. According to an exemplary embodiment, the system will group tasks by 30 days worth of age (e.g., less than 30 days old, more than 30 days old, more than 60 days old, more than 90 days old, etc.). According to various other exemplary embodiments the system may also be configured to track the time since the last database recordable activity associated with a project and/or task (e.g., how much “dust” has accumulated on the task). Therefore, if a new phone note, updated narrative, updated document or the like is added to a project and/or task record, the system may take some action. For example, the system may categorize the project as active rather than inactive. Inactive projects may be displayed on the task dashboard, allowing the user and/or managers to determine if a project is being ignored. If the task is determined to be too old, the system may be configured to generate one or more alerts (step 1118) of the type earlier described or otherwise.

Assignees of tasks and/or the user may continue to work and a user (e.g., the assignee) may indicate that a task is complete (step 1120). Upon receipt of this indication the system may determine whether all tasks are complete (step 1122). If all tasks are not complete, the process will loop back to step 1108. If all tasks have been completed, the project may be at an end. At the end of the project, or at any other time, the system may be configured to generate project reports or GUI screens similar to those shown in FIGS. 3-10 or otherwise (step 1124). Data may be stored, added, updated, edited, deleted, transformed or otherwise acted upon in one or more memory units or databases throughout the sales project (step 1126).

Referring now to FIG. 12, a flow chart of a process 1200 for managing a sales project using a computer system is shown, according to an exemplary embodiment. Process 1200 is shown to include the step of receiving an indication that a first task has been completed (step 1202). The indication may be received from a user via a GUI displayed on a computer display. Upon receipt of the indication the system is configured to prompt the user to annotate a record shown on the GUI and stored in a memory device relating to the completion of the first task (step 1204).

Upon completion of a task, the system may also be configured to prompt the user to archive documents relating to the first task (step 1206). Documents (e.g., word processor documents, PDF documents, e-mails, text messages, spreadsheets, computer-aided design documents, charts, plans, and/or any other type of electronic document) may be uploaded to the computer system via any number of mechanisms. For example, the GUI may provide a dialog box for allowing a user to browse his or her personal storage device (e.g., flash drive, hard drive, etc.) so that the documents contained thereon may be uploaded. According to other various exemplary embodiments documents may be dragged from a desktop, file browser, or another interface to a window of the GUI for managing the sales process. In these embodiments the computer includes processing logic for recognizing the drag-and-drop behavior and documents and includes processing logic for completing the transfer of those documents to a database. Each project may include a folder based structure (or at least apparent folder structure on the GUI for the user's benefit) for storing the archived documents. The system may be configured with logic to strip details from the archived documents for summarizing purposes, indexing purposes, search purposes and the like. For example, any e-mails archived to the system may be read to extract fields such as to, from, subject, and the like. The documents and/or any other annotation may be related to the appropriate task, project, customer, and/or user record in a database using table-based relationships or any other appropriate data structure for relating information (step 1208). Process 1200 is further shown to include the step of providing access to the documents archived in step 1208 based on permissions for the user or a group of users (step 1210). For example, all user may be able to see public documents but only certain users may be associated with permissions for viewing another user's e-mail records relating to a task.

Referring further to FIG. 12, process 1200 is further shown to include the step of displaying a prompt for an identifier of a second assignee (step 1212) for a next task. The prompt for the assignee may be generated and displayed when the user attempts to save a record indicating that a first task is complete. According to various other exemplary embodiments, this prompt may be generated immediately after a user has marked a task as complete. Prior to step 1212, it is important to note that according to various exemplary embodiments the system will automatically generate an alert that a new task or next task is needed in the system and will prompt the user and/or another user (e.g., a supervisor) to add and/or define the next task. Once the identifier for the second assignee is received by the computer system via the GUI, the system is configured to prompt the second assignee to accept the assignment of the second task (step 1214). The prompt may be transmitted to the second assignee via the GUI the next time the second assignee logs into the system. According to various other embodiments, the prompt to accept the assignment may be transmitted to the user via e-mail, text message, or another communications medium.

After the second assignee is prompted to accept the assignment of the second task, the system is configured to track a period of time since prompting the second assignee (step 216). The system can then check to determine whether the second assignee has accepted (e.g., within a threshold period of time) or if the second assignee has declined the assignment (step 1218). If the second assignee does not accept the assignment the system can notify the first assignee or another user (e.g., a sales manager, a project manager, etc.) of the second user's lack of acceptance (step 1220). The notification may be made via a user interface element displayed during use of the GUI, a text message, and/or an e-mail. The original user or another user may then be prompted to identify another potential assignee (step 1222). If the second assignee accepts the second task, the second assignee will be assigned the task in the system (step 1224). Accordingly, the second task will be added to the second assignee's task dashboard, to-do list, and the like. The process of completing tasks and assigning users to new tasks via automated prompting may continue until the sales project/process is complete (step 1226). It is important to note that assignment information is variously displayed on a GUI (e.g., GUI's shown in FIGS. 3-10) and/or assignment relationships are stored in databases of the systems (step 1228).

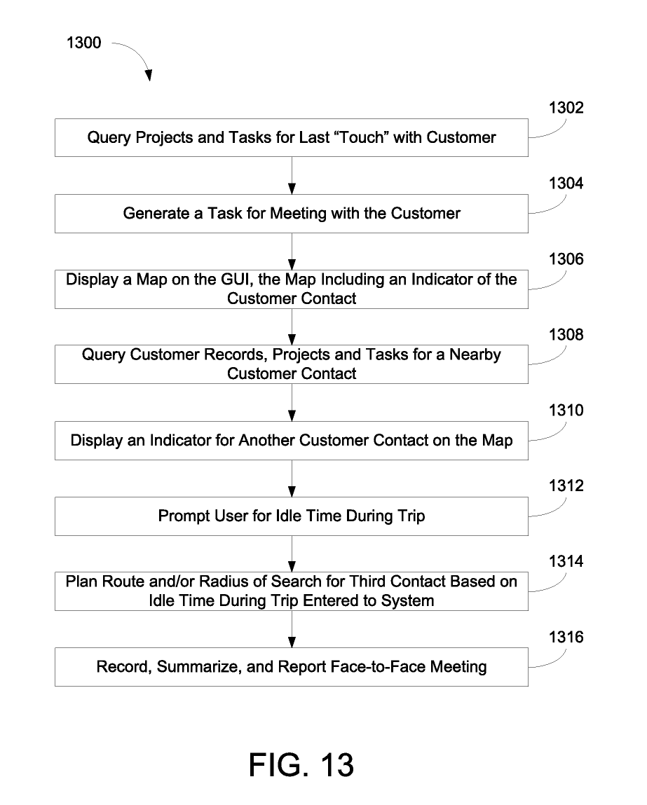

FIG. 13 is a flow chart of a process 1300 for managing a sales project using a computer system as described in the present application, according to an exemplary embodiment. Applicants have found that touches (e.g., face-to-face meetings, personal phone calls, etc.) are important during the sales project. Process 1300 includes the step of querying project records and/or task records for the date of the last touch with the customer or potential customer (step 1302). Based on step 1302, tasks may be generated for one or more sales projects for meeting with the customer (step 1304). The decision regarding whether to generate the meeting task and/or which customer will be the subject of the meeting task may determine on a number of variables, including, for example, the number of days since last touch, months since last touch, the type of the last task completed, the dollar potential for the sale, etc. The generation of the task for meeting with the customer may in fact create multiple tasks, one of which is to schedule the meeting. According to various exemplary embodiments the processing circuit of the computer system configured to generate the GUI can include logic for assisting with the scheduling task based on any number of variables and/or considerations. Among these considerations may be location for the customer contact. The processing circuit may include a mapping module configured to display a map on the GUI, the map including an indicator (e.g., icon, pin, coordinate, etc.) for the customer contact based on information in the contact database or entered by a user (step 1306). Once a first plan for meeting with a first customer at a first location is scheduled, the system may be configured to assist the user with making the most of his or her travel and time resources. To this end, the system can query customer records, potential customer records, project records, task records, and the like for another customer contact located near to the first customer contact (step 1308). The query may be configured to select the another customer contact based on any number of variables. For example, the system may be configured to select a customer contact that has not been “touched” recently, that is at a certain stage in the sales process, that has a certain business potential, that has given the company good sales in the past, or by any other determination. According to an exemplary embodiment the system is configured to query other data sources for potential customers that have not been entered into the actual contact database of the sales management system. The query or selection logic may include a weighting function that is user configurable for making the selection.

Once the another contact is selected via the query, a second indicator for the second customer contact can be added to the same map that is displaying the indicator for the first customer contact (step 1310). A part of the scheduling and/or selection process can include prompting the user for his or her idle time during the trip (step 1312). This way, the system can be configured to select a maximum radius from the first meeting for planning the second meeting. For example, if there are two potential customer contacts that can be met with during a user's idle time on a sales trip, the customer contact that is within a good driving range considering the user's idle time may be selected by logic of the computer system. According to an exemplary embodiment the system will present a number of customer contact options for the user via a list, via a number of color-coded indicators on the map, or the like. Idle time may also be used to plan a driving route and/or a radius of search for yet a third contact (step 1314). Because the computer system will know of the planned meetings via the planned tasks, the system will be configured to require the user to record, summarize, and/or report the subject matter and content of the face-to-face meeting after it occurs (step 1316). Step 1316 may include prompting the user for the summary upon the user's next log into the GUI, via text message, e-mail, and/or when the user views the meeting task or closes the meeting task.

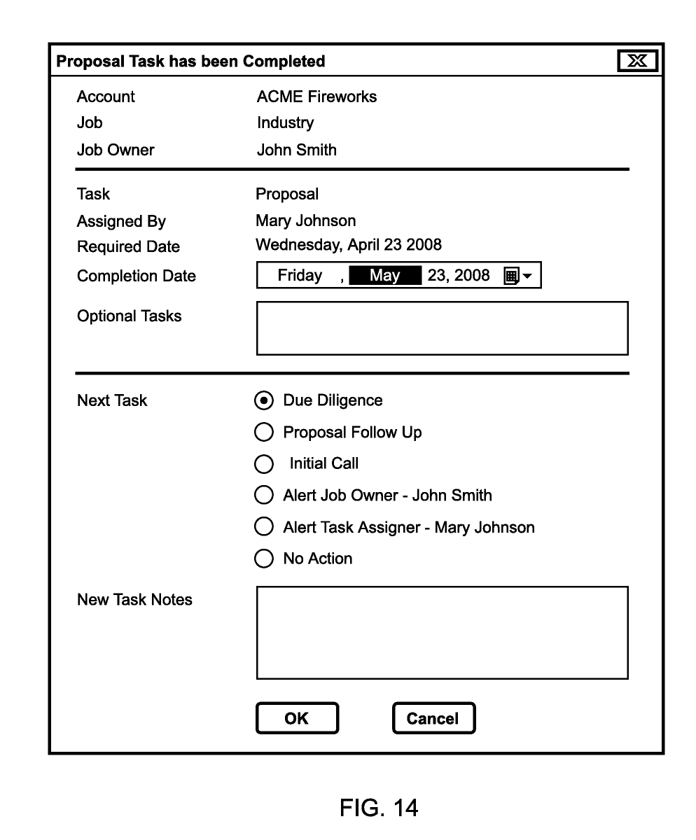

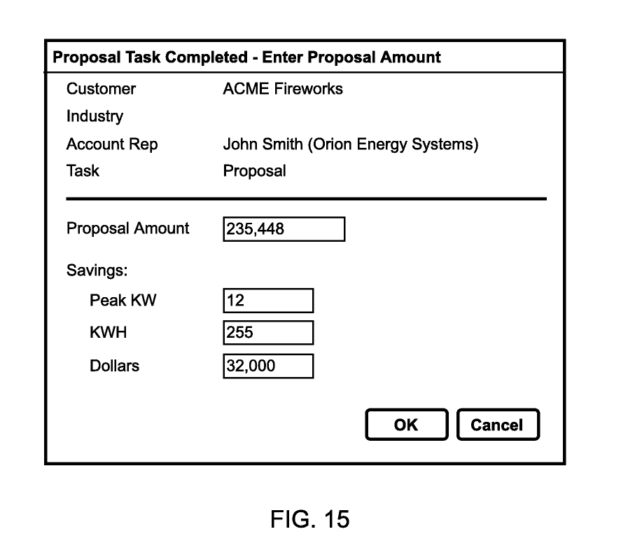

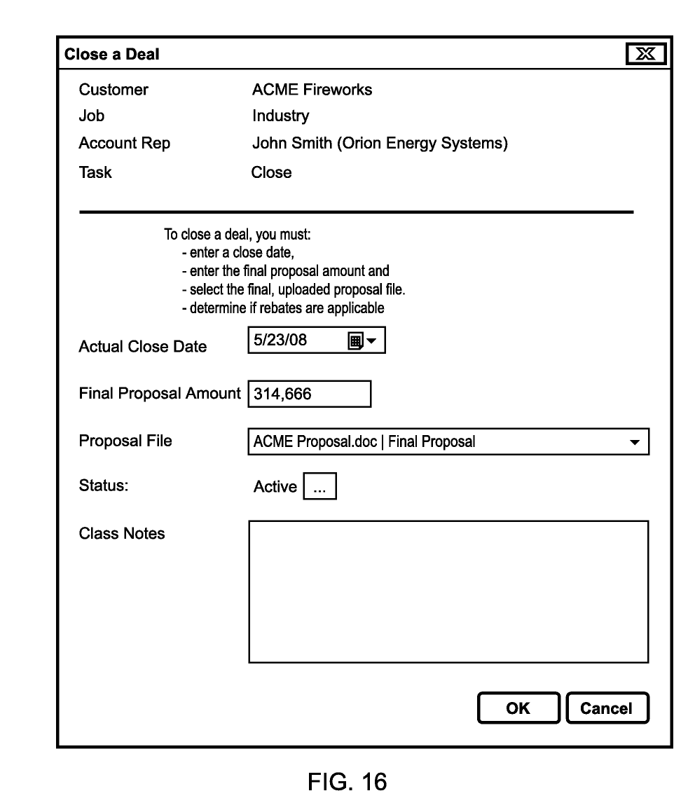

Referring now to FIG. 14-16, an illustration of GUIs provided by the computer system shown in FIGS. 1 and 2 is shown, according to an exemplary embodiment. In FIG. 14, a GUI may be provided when a task is completed. The GUI may include details about the finished task, provide the user with an interface for adding details regarding the finished task, and allow the user to create a new task based on the finished task. In the GUI of FIG. 15, a user may enter task details (e.g., a proposal amount or other proposal details if the task was a proposal). In the GUI of FIG. 16, data from the GUIs of FIG. 14-15 may be collected onto the GUI. The GUI of FIG. 16 may allow a user to finalize or “close” a proposal or other task.

It is important to note that some client computers (e.g., shown in FIGS. 1 and 2) may be given different permissions for accessing the sales management system. For example, system 200 may be configured to support a reseller network where resellers are only able to view their sales data or data relating to their sales (e.g., their territory, their market, etc.) and cannot view projects and/or tasks associated with the parent company and/or other resellers. Further, it is important to note that some third parties may be granted “shared” access to limited portions of the sales management software. For example, one or more contractors may be granted access to an installation management portion of the system and/or data relating to installation management so that they may more easily coordinate timing, resources, contacts, and the like. A contractor granted access to customer contact information may be able to contact customer contacts directly to work through an issue.

The construction and arrangement of the elements of the system are illustrative only. Although only a few exemplary embodiments of the present disclosure have been described in detail in this disclosure, those skilled in the art who review this disclosure will readily appreciate that many modifications are possible in these embodiments (such as variations in the design of the system or order of method steps etc.) without materially departing from the novel teachings and advantages of the disclosure. For example, while the systems and methods are described with reference to a sales project, it should be appreciated that the systems, methods, and graphical user interfaces may be modified to accommodate other task-based processes (e.g., customer service, warranty support, etc.).

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

Embodiments within the scope of the present disclosure include program products comprising machine-readable media for carrying or having machine-executable instructions or data structures stored thereon (e.g., program products/software for controlling variable frequency drives). Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

What is claimed is:

1. An method for managing a sales process via a graphical user interface (GUI) generated by a computer and displayed on a computer display, comprising:
defining a sales process, the sales process including a first task assigned to a first assignee and a second task;
at the GUI, displaying a prompt for an identifier of a second assignee upon receipt of an indication that the first task has been completed;
receiving the identifier of the second assignee; and
assigning the second assignee to the second task;
wherein the assignment of the second assignee to the second task is displayed on the computer display, stored in a computer memory device, or displayed on the computer display and stored in a computer memory device.

2. The method of claim 1, wherein the prompt is automatically generated upon reception of the indication that the first task has been completed.

3. The method of claim 1, further comprising:
prompting the second assignee to accept the assignment of the second task.

4. The method of claim 3, further comprising:
requiring the second assignee to accept the assignment of the second task within a period of time before notifying another user of the second assignee's lack of acceptance.

5. The method of claim 4, wherein the notification is via one or more of e-mail, text-message, and a generated report.

6. The method of claim 1, further comprising:
requiring the reception of the identifier of the second assignee before updating the first task as completed in a database.

7. The method of claim 1, further comprising:
providing an alert to another user if the identifier of the second assignee is not received within a predetermined period of time.

8. The method of claim 3, further comprising:
tracking a period of time since the acceptance of the second task and during which the second task remains uncompleted; and displaying an indication of the period of time via the computer display.

9. A computer for providing a GUI for managing a sales process, the sales process including a first task assigned to a first assignee and a second task for assigning to a second assignee, the computer comprising:
a memory unit; and
a processing circuit communicably coupled to the memory unit and configured to receive first input regarding the sales process via the GUI and to use the first input to define the sales process within the memory unit, wherein the processing circuit is further configured to receive an indication that the first task has been completed via the GUI and to cause the GUI to display a prompt for an identifier of the second assignee upon receipt of the indication, wherein the processing circuit is further configured to receive the identifier of the second assignee and to assign the second assignee to the second task, and wherein the processing circuit is further configured to cause the GUI to display a record of the assignment of the second assignee to the second task, to store the record in the memory unit, or to cause the GUI to display the record and to store the record.

10. The computer of claim 9, wherein the processing circuit is further configured to cause the GUI to display a second prompt for the second assignee, the second prompt asking the second assignee to accept the assignment of the second task, and wherein the processing circuit is further configured to require the second assignee to accept the assignment of the second task within a period of time before notifying another user of the second assignee's lack of acceptance; and wherein the notification is via one or more of e-mail, text-message, and a generated report.

11. The computer of claim 10, wherein the processing circuit is further configured to compute a period of time since the acceptance of the second task and during which the second task remains uncompleted, and wherein the processing circuit is further configured to cause the GUI to display an indication of the period of time, to store the computed period of time in the memory unit, or to cause the GUI to display the indication of the period of time and to store the computed period of time in the memory unit.

12. A system for managing a sales process, the system configured to generate a graphical user interface (GUI) for allowing a user to manage sales processes for a plurality of sales projects, the system comprising:
a processing circuit configured to maintain a record of a total cost for each sales project of the plurality of sales projects, wherein the processing circuit is configured to prompt the user for updated cost information after tasks relating to each sales project are updated as completed via the GUI; and
wherein the processing circuit is configured to display an indication of the total cost for a sales project of the plurality of sales projects near an indication of the potential revenue relating to the sales project on the graphical user interface of the system.

13. The system of claim 12, wherein the system is configured to provide an alert to a user of the system if total expenses for the sales project increase beyond the projected potential revenue relating to the sales project.

14. A system for managing a sales process, the system configured to generate a graphical user interface (GUI) for allowing a user to manage sales processes for a plurality of sales projects, the system comprising:
a processing circuit configured to maintain a record of the meeting instances during which a customer contact relating to the sales process met with a sales representative and wherein the processing circuit is further configured to calculate the period of time since the last meeting instance and to prompt the user to initiate a sales process task for meeting with the customer contact; and
wherein the processing circuit is further configured to display a map on the graphical user interface, the map including an indicator of a location associated with the customer contact and at least another indicator for another customer contact.

15. The system for managing a sales process of claim 14, wherein the processing circuit is configured to select the another customer contact based on a period of time since a face-to-face meeting with the another customer contact.

16. The system for managing a sales process of claim 14, wherein the processing circuit is configured to select the another customer contact based on previous sales, projected sales, or previous sales and projected sales.

17. A machine readable storage medium storing a computer program for use by a computer and for managing a sales process via a graphical user interface (GUI) generated by the computer and displayed on a computer display, the computer program being adapted to make a computer execute the process comprising the steps of:
defining the sales process, the sales process including a first task assigned to first assignee and a second task;
at the GUI, displaying a prompt for an identifier of a second assignee upon receipt of an indication that the first task has been completed; receiving the identifier of the second assignee; and
assigning the second assignee to the second task;
wherein the assignment of the second assignee to the second task is displayed on the computer display and/or stored in a computer memory device.

18. A first computer for transmitting a computer program for use by a second computer, the computer program being adapted to make the second computer execute the process comprising the steps of:
defining the sales process, the sales process including a first task assigned to first assignee and a second task;
at the GUI, displaying a prompt for an identifier of a second assignee upon receipt of an indication that the first task has been completed; receiving the identifier of the second assignee; and
assigning the second assignee to the second task;
wherein the assignment of the second assignee to the second task is displayed on the computer display and/or stored in a computer memory device.

19. The first computer of claim 18, wherein the prompt is automatically presented upon reception of the indication that the first task has been completed, and wherein the process further comprises the step of prompting the second assignee to accept the assignment of the second task.

20. The first computer of claim 19, wherein the process further comprises:
requiring the second assignee to accept the assignment of the second task within a period of time before notifying another user of the second assignee's lack of acceptance and wherein the notification is via one or more of e-mail, text-message, and a generated report.
